(19) United States
(12) Patent Application Publication
(10) Pub. No.: US 2018/0149876 A1
(43) Pub. Date: May 31, 2018

(54) METHOD AND APPARATUS FOR CONTROLLING THREE-DIMENSIONAL DISPLAY DEVICE, AND THREE-DIMENSIONAL DISPLAY DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Qian WANG, Beijing (CN); Pengcheng LU, Beijing (CN); Ming YANG, Beijing (CN); Xiaochuan CHEN, Beijing (CN); Xue DONG, Beijing (CN); Jian GAO, Beijing (CN)

(73) Assignees: BOE TECHNOLOGY GROUP CO., LTD., Beijing (CN); BEIJING BOE OPTOELECTRONICS TECHNOLOGY CO., LTD., Beijing (CN)

(21) Appl. No.: 15/518,110

(22) PCT Filed: Dec. 21, 2015
(86) PCT No.: PCT/CN2015/098056

§ 371 Date: Apr. 10, 2017

(30) Foreign Application Priority Data
Aug. 20, 2015 (CN) 201510516134.3

(51) Int. Cl. G02B 27/22

(52) U.S. Cl. CPC G02B 27/22; H04N 13/0402

(57) ABSTRACT

A method and an apparatus for controlling a 3D display device, and the 3D display device are provided. The method includes within a first time period for outputting one frame, applying a first control signal to enable a left eye of a user to view a first view on the display panel at a first effect through the grating structure, and enable a right eye of the user to view a second view on the display panel at the first effect through the grating structure, and within a second time period for outputting one frame, applying a second control signal, to enable the left eye of the user to view the first view on the display panel at a second effect through the grating structure, and enable the right eye of the user to view the second view on the display panel at the second effect through the grating structure.

### CROSS-REFERENCE TO RELATED APPLICATION

The present application claims a priority of the Chinese patent application No. 201510516134.3 filed on Aug. 20, 2015, which is incorporated herein by reference in its entirety.

### TECHNICAL FIELD

The present disclosure relates to the field of three-dimensional (3D) display technology, in particular to a method and an apparatus for controlling a 3D display device, and the 3D display device.

### BACKGROUND

Along with progress of science and technology, 3D display technology has been applied more and more widely in our lives. Glassless 3D technology can provide a 3D display effect without any 3D glasses, so it has broad application prospects and has become a research emphasis for various 3D display manufacturers.

The conventional glassless 3D technology mainly includes three types, i.e., Parallax Barrier, Lenticular Lens and Directional Backlight. For a Parallax Barrier 3D display device, it has relatively low pixels per inch (PPI), so the 3D display effect may be adversely affected.

### SUMMARY

An object of the present disclosure is to provide a method and an apparatus for controlling a 3D display device, and the 3D display device, so as to increase the PPI of the Parallax Barrier 3D display device.

In one aspect, the present disclosure provides in some embodiments a method for controlling a 3D display device, the 3D display device including a display panel for displaying a two-dimensional (2D) image and a grating structure cooperating with the display panel to provide a 3D display effect, the method including steps of: within a first time period for outputting one frame, applying a first control signal to enable a left eye of a user to view a first view on the display panel at a first effect through the grating structure, and enable a right eye of the user to view a second view on the display panel at the first effect through the grating structure; and within a second time period for outputting one frame, applying a second control signal, to enable the left eye of the user to view the first view on the display panel at a second effect through the grating structure, and enable the right eye of the user to view the second view on the display panel at the second effect through the grating structure.

In a possible embodiment of the present disclosure, in the step of applying the first control signal, the first control signal includes a first signal applied to the display panel and a second signal applied to the grating structure, and in the step of applying the second control signal, the second control signal includes a third signal different from the first signal and applied to the display panel and a fourth signal identical to the second signal and applied to the grating structure.

In a possible embodiment of the present disclosure, the step of applying the first control signal to enable the left eye of the user to view the first view on the display panel at the first effect through the grating structure and enable the right eye of the user to view the second view on the display panel at the first effect through the grating structure includes: enabling a first group of gratings of the grating structure, which are spaced apart from each other, to be transparent portions, enabling a second group of gratings each arranged between the adjacent gratings in the first group to be nontransparent portions, enabling a plurality of first pixel units arranged on the display panel and spaced apart from each other to display the first view at the first effect, and enabling a plurality of second pixel units each arranged between the adjacent first pixel units on the display panel to display the second view at the first effect. The step of applying the second output signal to enable the left eye of the user to view the first view on the display panel at the second effect through the grating structure and enable the right eye of the user to view the second view on the display panel at the second effect through the grating structure includes: enabling the first group of gratings spaced apart from each other to be transparent portions, enabling the second group of gratings spaced apart from each other to be nontransparent portions, enabling the first pixel units to display the first view at the second effect and enabling the second pixel units to display the second view at the second effect.

In a possible embodiment of the present disclosure, in the step of applying the first control signal, the first control signal includes a first signal applied to the display panel and a second signal applied to the grating structure, and in the step of applying the second control signal, the second control signal includes a third signal different from the first signal and applied to the display panel and a fourth signal different from the second signal and applied to the grating structure. Transparent portions of the grating structure are located at different positions in accordance with the second signal and the fourth signal.

In a possible embodiment of the present disclosure, the step of applying the first control signal to enable the left eye of the user to view the first view on the display panel at the first effect through the grating structure, and enable the right eye of the user to view the second view on the display panel at the first effect through the grating structure includes: enabling a first group of gratings of the grating structure, which are spaced apart from each other, to be transparent portions, enabling a second group of gratings each arranged between the adjacent gratings in the first group to be nontransparent portions, enabling a plurality of first pixel units arranged on the display panel and spaced apart from each other to display the first view at the first effect, and enabling a plurality of second pixel units each arranged between the adjacent first pixel units on the display panel to display the second view at the first effect. The step of applying the second control signal to enable the left eye of the user to view the first view on the display panel at the second effect through the grating structure and enable the right eye of the user to view the second view on the display panel at the second effect through the grating structure includes: enabling the second group of gratings of the grating structure to be transparent portions, enabling the first group of gratings to be nontransparent portions, enabling the plurality of second pixel units spaced apart from each other on the display panel to display the first view at the second effect, and enabling the plurality of first pixel units spaced apart from each other on the display panel to display the second view at the second effect.

In a possible embodiment of the present disclosure, within the first time period for outputting one frame, the first control signal is applied, to enable the left eye of the user to view on the display panel the first view outputted by the plurality of first pixel units spaced apart from each other through the grating structure, thereby to view the first view at the first effect; and enable the right eye of the user to view on the display panel the second view outputted by the plurality of second pixel units spaced apart from each other through the grating structure, thereby to view the second view at the first effect. Within the second time period for outputting one frame, the second control signal is applied, to enable the left eye of the user to view on the display panel the first view outputted by the plurality of second pixel units through the grating structure, thereby to view the first view at the second effect; and enable the right eye of the user to view on the display panel the second view outputted by the plurality of first pixel units through the grating structure, thereby to view the second view at the second effect.

In a possible embodiment of the present disclosure, the first time period and the second time period form a display period for one frame.

In a possible embodiment of the present disclosure, the first effect is different from the second effect. The first effect is used to represent positions of pixel units on the display panel corresponding to the first view and the second view within the first time period, brightness values of at least parts of the pixel units on the display panel within the first time period, and/or contrast values of at least parts of the pixel units on the display panel within the first time. The second effect is used to represent positions of pixel units on the display panel corresponding to the first view and the second view within the second time period, brightness values of at least parts of the pixel units on the display panel within the second time period, and/or contrast values of at least parts of the pixel units on the display panel within the second time period.

In another aspect, the present disclosure provides in some embodiments an apparatus for controlling a 3D display device, the 3D display device including a display panel for displaying a 2D image and a grating structure cooperating with the display panel to provide a 3D display effect, the apparatus including: a first controller configured to, within a first time period for outputting one frame, apply a first control signal to enable a left eye of a user to view a first view on the display panel at a first effect through the grating structure, and enable a right eye of the user to view a second view on the display panel at the first effect through the grating structure; and a second controller configured to, within a second time period for outputting one frame, apply a second control signal, to enable the left eye of the user to view the first view on the display panel at a second effect through the grating structure, and enable the right eye of the user to view the second view on the display panel at the second effect through the grating structure.

In a possible embodiment of the present disclosure, the first control signal applied by the first controller includes a first signal applied to the display panel and a second signal applied to the grating structure, and the second control signal applied by the second controller includes a third signal different from the first signal and applied to the display panel and a fourth signal identical to the second signal and applied to the grating structure.

In a possible embodiment of the present disclosure, the first control signal applied by the first controller includes a first signal applied to the display panel and a second signal applied to the grating structure, and the second control signal applied by the second controller includes a third signal different from the first signal and applied to the display panel and a fourth signal different from the second signal and applied to the grating structure.

In a possible embodiment of the present disclosure, the first effect is different from the second effect. The first effect is used to represent positions of pixel units on the display panel corresponding to the first view and the second view within the first time period, brightness values of at least parts of the pixel units on the display panel within the first time period, and/or contrast values of at least parts of the pixel units on the display panel within the first time. The second effect is used to represent positions of pixel units on the display panel corresponding to the first view and the second view within the second time period, brightness values of at least parts of the pixel units on the display panel within the second time period, and/or contrast values of at least parts of the pixel units on the display panel within the second time period.

In yet another aspect, the present disclosure provides in some embodiments a 3D display device including the above-mentioned apparatus, a display panel for displaying a 2D image and a grating structure cooperating with the display panel to provide a 3D display effect.

In a possible embodiment of the present disclosure, the grating structure is formed as an organic light-emitting diode (OLED) display screen and arranged at a rear side of the display panel. The OLED display screen includes a plurality of light-emitting units arranged parallel to each other. Each light-emitting unit forms a transparent portion of the grating structure in the case of emitting light, and forms a nontransparent portion of the grating structure in the case of not emitting light.

According to the method and apparatus for controlling the 3D display device, and the 3D display device in the embodiments of the present disclosure, within the display period for one frame, in the case of switching from the first time period into the second time period, each of the left eye and the right eye of the user may view the view at different effects. As compared with the related art where the view may be viewed by each of the left eye and the right eye of the user at a fixed effect within an identical display period for one frame, it is able for each of the left eye and the right eye to acquire more image information, thereby to improve the PPI while achieving the 3D display effect.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain other drawings without any creative effort.

FIG. 1 is a schematic view showing a principle of applying a control method to a 3D display device according to at least one embodiment of the present disclosure;

FIG. 2 is a schematic view showing a state of the 3D display device within a first time period according to at least one embodiment of the present disclosure;

FIG. 3 is another schematic view showing a state of the 3D display device within a second time period according to at least one embodiment of the present disclosure;

FIG. 4 is a schematic view showing the 3D display device with the control apparatus according to at least one embodiment of the present disclosure; and

FIG. 5 is another schematic view showing the 3D display device according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “a” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

The present disclosure provides in some embodiments a method for controlling a 3D display device. The 3D display device includes a display panel for displaying a two-dimensional (2D) image and a grating structure cooperating with the display panel to provide a 3D display effect. The method includes steps of: within a first time period for outputting one frame, applying a first control signal so as to enable a left eye of a user to view a first view on the display panel at a first effect through the grating structure, and enable a right eye of the user to view a second view on the display panel at the first effect through the grating structure; and within a second time period for outputting one frame, applying a second control signal, so as to enable the left eye of the user to view the first view on the display panel at a second effect through the grating structure, and enable the right eye of the user to view the second view on the display panel at the second effect through the grating structure.

According to the method in the embodiments of the present disclosure, within a display period for one frame, in the case of switching from the first time period into the second time period, each of the left eye and the right eye of the user may view the view at different effects. As compared with the related art where the view may be viewed by each of the left eye and the right eye of the user at a fixed effect within an identical display period for one frame, it is able for each of the left eye and the right eye to acquire more image information, thereby to improve the PPI while achieving a 3D display effect.

To be specific, within the display period for one frame, the first view viewed by the left eye may remain unchanged within the first time period and the second time period, and so does the second view viewed by the right eye. However, each view may be viewed at different display effects within the first time period and the second time period respectively. This difference in the display effects may be a change in positions of pixel units corresponding to the view on the display panel. In other words, although the fixed views may be viewed by the left and right eyes respectively within the display period for one frame, the pixel units on the display panel corresponding to each of the first view viewed by the left eye and the second view viewed by the right eye may change upon the first time period ends and the second time period starts, so the views may be viewed by the left and right eyes respectively at different display effects within the first time period and the second time period respectively, so as to provide more image information.

In addition, within the first time period and the second time period, the difference in the display effects of the view viewed by each of the left and right eyes may be a change in a brightness value or a contrast value. In other words, although the fixed view may be viewed by each of the left and right eyes within the display period for one frame, the brightness value or contrast value of each of the first view viewed by the left eye and the second view viewed by the right eye may change upon the first time period ends and the second time period starts, or the brightness value or contrast value of parts of the pixel units on the display panel may change upon the first time period ends and the second time period starts so the view may be viewed by each of the left and right eyes at different display effects within the first time period and the second time period respectively, so as to provide more image information.

According to the method in the embodiments of the present disclosure, in the case that the a 2D display panel outputs an image at a fixed refresh rate, it may display, through cooperating with the grating structure, two views within the display period for outputting one frame, so as to: within the first time period, enable the left eye of the user to merely view the first view on the display panel at the first effect and enable the right eye of the user to merely view the second view on the display panel at the first effect, thereby to combine the first view and the second view in the user's brain to achieve the 3D effect; and within the second time period, enable the left eye of the user to merely view the first view on the display panel at the second effect and enable the right eye of the user to merely view the second view on the display panel at the second effect, thereby to combine the first view and the second view in the user's brain to achieve the 3D effect. As compared with the related art, it is able for the left and right eyes to acquire more image information within the display period for one frame through the method in the embodiments of the present disclosure, thereby to increase the PPI while achieving the 3D display effect.

The 3D display device and the control method adopted thereby will be described hereinafter in conjunction with the drawings.

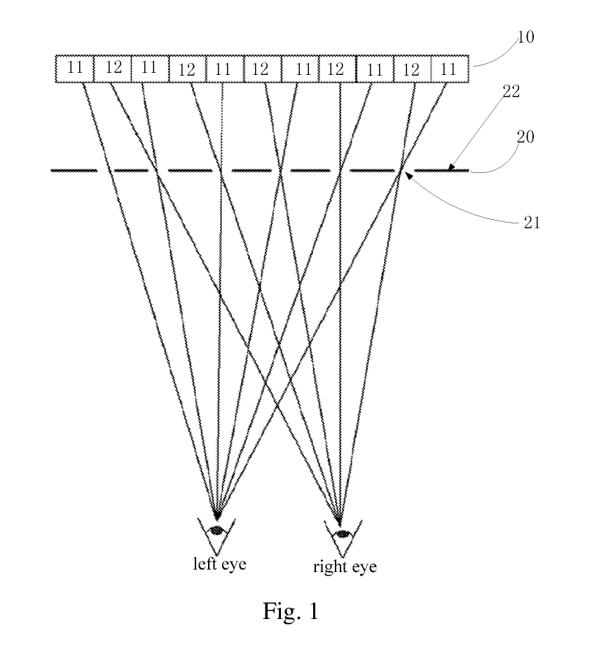

FIG. 1 shows a principle of applying a control method to a Parallax Barrier 3D display device according to at least one embodiment of the present disclosure, and this 3D display device is also a common front-Parallax Barrier 3D display device. The 3D display device includes a display panel 10 and a grating structure 20. The grating structure 20 is arranged opposite to the display panel 10 and in front of the display panel 10. In the case of displaying a 3D image, the grating structure 20 may include transparent portions 21 and nontransparent portions 22 arranged alternately. In the case that light beams from the display panel 10 are transmitted through the transparent portions 21, the light beams from parts of pixel units on the display panel 10 may be transmitted through the transparent portions 21 and reach the left eye of the viewer, and light beams from the other parts of pixel units may be transmitted through the transparent portions 21 and reach the right eye of the viewer. In the case that the views viewed by the left and right eyes are different from each other, they may be combined in the viewer's brain so as to provide the 3D display effect.

As shown in FIG. 1, usually, a plurality of first pixel units 11 spaced apart from each other on the display panel 10 may correspond to the viewer's left eye so as to display the first view within the display period for outputting one frame, and a plurality of second pixel units 12 each arranged between the adjacent first pixel units 11 may correspond to the viewer's right eye so as to display the second view within the display period for outputting one frame.

In addition, in a possible embodiment of the present disclosure, the grating structure 20 of the 3D display device may consist of slits at fixed positions, i.e., positions of the transparent portions 21 and the nontransparent portions 22 may be fixed and non-adjustable. In another possible embodiment of the present disclosure, the grating structure 20 may consist of slits at adjustable positions, i.e., the positions of the transparent portions 21 and the nontransparent portions 22 may be adjustable in accordance with the practical need. The adjustable grating structure 20 may include a first electrode layer, a second electrode layer arranged opposite to the first electrode layer, and a liquid crystal layer arranged between the first electrode layer and the second electrode layer. The first electrode layer may consist of a plurality of first electrodes arranged parallel to each other. A voltage may be applied between the first electrode layer and the second electrode layer, and different voltages may be applied to the first electrodes respectively, so as to provide liquid crystals in the liquid crystal layer with different deflection states, thereby to allow or prohibit the transmission of the light beams, and form the transparent portions and the nontransparent portions arranged alternately.

The above-mentioned 3D display principle is known in the art, and a person skilled in the art may understand the structure and the operating principle of the 3D display device. In addition, this is not a research emphasis of the present disclosure, and thus will not be further particularly defined herein.

The method in the embodiments of the present disclosure may be applied to the grating structure with the slits at fixed positions or to the grating structure with the slits at adjustable positions.

To be specific, according to the method in the embodiments of the present disclosure, within the display period for outputting one frame, the brightness value or contrast value of the view viewed by each of the left and right eyes, or the brightness value or contrast value of the corresponding pixel units, may change upon the first time period ends and the second time period. In the case of a fixed refresh rate for the display panel, it is able for each of the left and right eyes to acquire more image information, thereby to increase the PPI while achieving the 3D display effect.

To be specific, in order to implement the above-mentioned method, the control signals for the 3D display device method will be described hereinafter in more details.

As shown in FIG. 1, within the first time period for outputting one frame, in the case of outputting the first control signal, the first control signal may include a first signal applied to the display panel 10 and a second signal applied to the grating structure 20. Through the first signal, the first pixel units 11 on the display panel 10 may output the first view, and the second pixel units 12 on the display panel 10 may output the second view. Through the second signal, the grating structure 20 may be of a structure consisting of the nontransparent portions 22 and the transparent portions 21 arranged alternately as shown in FIG. 1, the first view may be viewed by the left eye of the viewer through the transparent portions 21 and the second view may be viewed by the right eye of the viewer through the transparent portions 21.

Within the second time period for outputting one frame, in the case of outputting the second control signal, the second control signal may include a third signal different from the first signal and applied to the display panel and a fourth signal identical to the second signal and applied to the grating structure 20. Through the third signal, the first pixel units 11 on the display panel 10 may also output the first view, and the second pixel units 12 may also output the second view. However, as compared with the first time period, the brightness value or contrast value of each of the first view and the second view may change. In other words, as compared with the first control signal applied within the first time period, the signal applied to the grating structure 20 may remain unchanged, while the signal applied to the display panel may change. In this way, it is able to change the brightness value or contrast value of each of the first view and the second view while keeping the contents of the first view and the second view being unchanged.

To be specific, the brightness value or contrast value of the image displayed on the display panel may change by adjusting voltages applied to two sides of a liquid crystal layer of the display panel 10.

In addition, in order to implement the method in the at least one embodiment of the present disclosure, states of the grating structure and the display panel of the 3D display device will be described hereinafter.

As shown in FIG. 1, the step of, within the first time period for outputting one frame, applying the first control signal so as to enable the left eye of the user to view the first view on the display panel 10 at the first effect through the grating structure 20 and enable the right eye of the user to view the second view on the display panel 10 at the first effect through the grating structure 20 includes: enabling a first group of gratings of the grating structure 20, which are spaced apart from each other, to be the transparent portions 21, enabling a second group of gratings each arranged between the adjacent gratings in the first group to be the nontransparent portions 22, enabling the plurality of first pixel units 11 arranged on the display panel 10 and spaced apart from each other to display the first view at the first effect, and enabling the plurality of second pixel units 12 each arranged between the adjacent first pixel units 11 on the display panel 10 to display the second view at the first effect.

The step of, within the second time period for outputting one frame, applying the second output signal, so as to enable the left eye of the user to view the first view on the display panel 10 at the second effect through the grating structure 20 and enable the right eye of the user to view the second view on the display panel 10 at the second effect through the grating structure 20 includes: enabling the first group of gratings spaced apart from each other to be the transparent portions 21, enabling the second group of gratings spaced apart from each other to be the nontransparent portions 22, i.e. positions of the transparent portions 21 and the nontransparent portions 22 of the grating structure 20 being fixed; enabling the first pixel units 11 to display the first view at the second effect and enabling the second pixel units 12 to display the second view at the second effect.

In other words, according to the method in the at least one embodiment of the present disclosure, within the first time period and the second time period, the grating structure of the 3D display device may remain unchanged. In addition, for the display panel, the positions of the pixel units for displaying the first view corresponding to the left eye and the pixel units for displaying the second view corresponding to the right eye may remain unchanged, but each of the first view and the second view may be displayed at different effects.

According to the method in the embodiments of the present disclosure, for the display period for outputting one frame, within the second time period following the first time period, it is able to adjust the control signal applied to the display panel, so as to enable each of the left and right eyes to view the respective view at a display effect different from the display effect within the first time period.

The method has been described hereinbefore by taking the 3D display device with the grating structure being arranged in front of the display panel, i.e., the front-Parallax Barrier 3D display device, as an example. It should be appreciated that, the above method may also be applied to the rear-Parallax Barrier 3D display device, which will not be particularly defined herein.

In addition, according to the method in the at least one embodiment of the present disclosure, it is also able to change the positions of the pixel units on the display panel corresponding to the views viewed by the left and right eyes, respectively, upon the first time period ends and the second time period starts, so as to enable each of the left and right eyes to view the view at different effects within the first time period and the second time period, thereby to acquire more image information.

Based on the above principle, in the at least one embodiments of the present disclosure, the method may include steps of: within the first time period for outputting one frame, outputting the first control signal, so as to: enable the left eye of the user to view the first view outputted by the plurality of first pixel units on the display panel through the grating structure, thereby to display the first view at the first effect, and enable the right eye of the user to view the second view outputted by the plurality of second pixel units on the display panel through the grating structure, thereby to display the second view at the first effect; and within the second time period for outputting one frame, outputting the second control signal, so as to: enable the left eye of the user to view the first view outputted by the plurality of second pixel units on the display panel through the grating structure, thereby to display the first view at the second effect, and enable the right eye of the user to view the second view outputted by the plurality of first pixel units on the display panel through the grating structure, thereby to display the second view at the second effect.

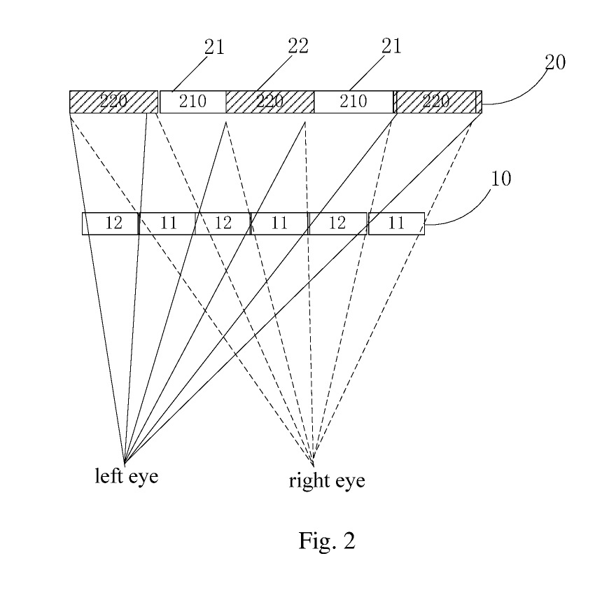

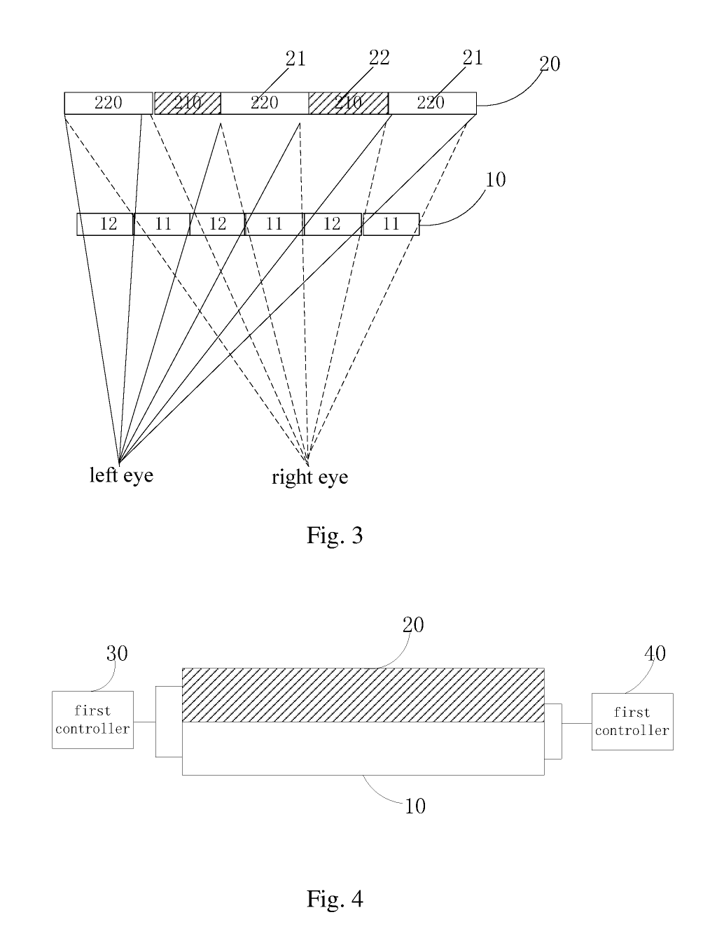

To be specific, in the at least one embodiments of the present disclosure, as shown in FIGS. 2 and 3 which are schematic views showing the Parallax Barrier 3D display device, the 3D display device may include the display panel 10 and the grating structure 20. In this embodiment, the grating structure 20 may be arranged opposite to the display panel 10 and in back of the display panel 10. The grating structure 20 may be an OLED display screen and function as a backlight unit for the display panel 10. The OLED display screen may include a plurality of light-emitting units arranged parallel to each other. In the case of emitting light, the light-emitting units may form the transparent portions of the grating structure corresponding to parts of the pixel units on the display panel 10, so as to enable each of the left and right eyes to view the corresponding view through the transparent portions.

The structure of the 3D display device with the OLED display screen as the backlight unit is known in the art, and thus will not be further particularly defined herein.

The control signals for the 3D display device adopting the above-mentioned method will be described hereinafter in more details.

As shown in FIG. 2, in the case of applying the first control signal within the first time period for outputting one frame, the first control signal may include a first signal applied to the display panel 10 and a second signal applied to the grating structure 20. Through the first signal, the first pixel units 11 on the display panel 10 may output the first view, and the second pixel units 12 on the display panel 10 may output the second view. Through the second signal, the grating structure 20 may be of a structure consisting of the nontransparent portions 22 and the transparent portions 21 arranged alternately as shown in FIG. 2 in such a manner that the left eye of the viewer may view the first view through the transparent portions 21 and the right eye of the viewer may view the second view through the transparent portions 21. In other words, the first pixel units 11 on the display panel 10 may correspond to the left eye, and the second pixel units 12 on the display panel 10 may correspond to the right eye.

In the case of applying the second control signal within the second time period for outputting one frame, the second control signal may include a third signal different from the first signal and applied to the display panel 10 and a fourth signal different from the second signal and applied to the grating structure 20. Through the third signal, the second pixel units 12 on the display panel 10 may output the second view, and the first pixel units 11 may output the first view. Through the fourth signal, as compared with the second signal, the transparent portions and the nontransparent portions of the grating structure 20 may be replaced with each other. In this way, as shown in FIG. 3, the second pixel units 12 on the display panel 10 may correspond to the left eye, and the first pixel units 11 may correspond to the right eye.

In addition, the states of the grating structure 20 and the display panel 10 of the 3D display device will be described hereinafter.

As shown in FIG. 2, the step of applying the first control signal so as to enable the left eye of the user to view the first view on the display panel 10 at the first effect through the grating structure 20 and enable the right eye of the user to view the second view on the display panel 10 at the first effect through the grating structure 20 includes: enabling a first group of gratings 210 of the grating structure 20, which are spaced apart from each other, to be the transparent portions 21, enabling a second group of gratings 220 each arranged between the adjacent gratings 210 in the first group to be the nontransparent portions 22, enabling the plurality of first pixel units 11 arranged on the display panel 10 and spaced apart from each other to display the first view, and enabling the plurality of second pixel units 12 each arranged between the adjacent first pixel units 11 on the display panel 10 to display the second view. In this way, as shown in FIG. 2, the left eye of the user may correspond to the first pixel units 11 and may view the first view outputted by the first pixel units 11, and the right eye of the user may correspond to the second pixel units 12 and may view the second view outputted by the second pixel units 12.

The step of applying the second control signal so as to enable the left eye of the user to view the first view on the display panel 10 at the second effect through the grating structure 20 and enable the right eye of the user to view the second view on the display panel 10 at the second effect through the grating structure 20 includes: enabling the first group of gratings 210 spaced apart from each other to be the nontransparent portions 22, enabling the second group of gratings 220 spaced from each other to be the transparent portions 21, enabling the plurality of second pixel units 12 spaced apart from each other on the display panel 10 to display the first view, and enabling the plurality of first pixel units 11 spaced apart from each other on the display panel 10 to display the second view. In this way, as shown in FIG. 3, the left eye of the user may correspond to the second pixel units 12 but still may view the first view, and the right eye of the user may correspond to the first pixel units 11 but still may view the second view. As compared with the first time period, the view viewed by each of the left and right eyes may remain unchanged, but the view is displayed by pixel units adjacent to the pixel units for displaying the view within the first time period, so it is able to provide a different display effect.

Through the above-mentioned method, as compared with the first control signal applied within the first time period, the signals applied to the display panel 10 and the grating structure 20 may change within the second time period, so as to enable the display panel 10 to match the grating structure 20, and enable the positions of the first view and the second view viewed by the left and right eyes to change relative to the display panel while keeping the contents of the first and second views being unchanged, thereby to provide different display effects. Hence, as compared with the related art where the view may be viewed by each of the left eye and the right eye of the user at a fixed effect within an identical display period for one frame, it is able for each of the left eye and the right eye to acquire more image information, thereby to improve the PPI while achieving the 3D display effect.

It should be appreciated that, the above-mentioned method may also be applied to, apart from a rear-Parallax Barrier 3D display device, a front-Parallax Barrier 3D display device, which will not be particularly defined herein.

In the at least two embodiments of the present disclosure, the first time period and the second time period may form a display period for one frame, and further, the first time period may be equal to the second time period. For example, in the case that the display panel outputs an image at a refresh rate of 120 Hz, within the first half of one refresh period, the left eye may view the first view at the first effect and the right eye may view the second view at the first effect, so as to provide the 3D effect. Within the second half of one refresh period, the left eye may view the first view at the second effect and the right eye may view the second view at the second effect, so as to provide the 3D effect.

As mentioned above, in the at least two embodiments of the present disclosure, the display period for one frame may be divided into two time periods, and the method for controlling the 3D display device has been described by taking the different display effects of the same view viewed by the each of the left and right eyes within the two time periods as an example. It should be appreciated that, in the case that the display period for one frame is divided into more than two time periods, it is still able for the user to acquire more image information within the time period for one frame, thereby to increase the PPI while achieving the 3D display effect.

The present disclosure further provides in some embodiments an apparatus for controlling a 3D display device, as shown in FIG. 4. The 3D display device includes a display panel 10 for displaying a 2D image and a grating structure 20 cooperating with the display panel 10 to provide a 3D display effect. The controlling apparatus includes: a first controller 30 configured to, within a first time period for outputting one frame, apply a first control signal so as to enable a left eye of a user to view a first view on the display panel 10 at a first effect through the grating structure 20, and enable a right eye of the user to view a second view on the display panel 10 at the first effect through the grating structure 20; and a second controller 40 configured to, within a second time period for outputting one frame, apply a second control signal, so as to enable the left eye of the user to view the first view on the display panel 10 at a second effect through the grating structure 20, and enable the right eye of the user to view the second view on the display panel 10 at the second effect through the grating structure 20.

In the at least one embodiment of the present disclosure, the first control signal applied by the first controller 30 includes a first signal applied to the display panel 10 and a second signal applied to the grating structure 20, and the second control signal applied by the second controller 40 includes a third signal different from the first signal and applied to the display panel 10 and a fourth signal identical to the second signal and applied to the grating structure 20.

To be specific, the second control signal is applied, such that as compared with the first control signal applied within the first time period, the signal applied to the grating structure 20 may remain unchanged and the signal applied to the display panel 10 may change within the second time period. In this way, the contents of the first view and the second view are kept unchanged, while it is able to change the display effects of the first view and the second view, e.g., change a brightness value or contrast value.

In the at least one embodiment of the present disclosure, the first control signal applied by the first controller 30 includes a first signal applied to the display panel 10 and a second signal applied to the grating structure 20, and the second control signal applied by the second controller 40 includes a third signal different from the first signal and applied to the display panel 10 and a fourth signal different from the second signal and applied to the grating structure 20.

In the at least one embodiment of the present disclosure, the second control signal is applied, such that as compared with the first control signal applied within the first time period, the signals applied to the grating structure 20 and the display panel 10 may change, so as to, e.g. enable the 3D display device to be in the two states as shown in FIGS. 2 and 3. At this time, the transparent portions and the nontransparent portions of the grating structure 20 may be replaced with each other, so that the pixel units on the display panel 10 corresponding to the left eye and the pixel units on the display panel 10 corresponding to the right eye may be replaced with each other. In this way, although the view viewed by each of the left and right eyes may remain unchanged, the corresponding pixel units on the display panel as well as the display effect may be changed, so it is able for the user to acquire more image information.

The present disclosure further provides in some embodiments a 3D display device, including the above-mentioned controlling apparatus, a display panel for displaying a 2D image, and a grating structure cooperating with the display panel to provide a 3D display effect.

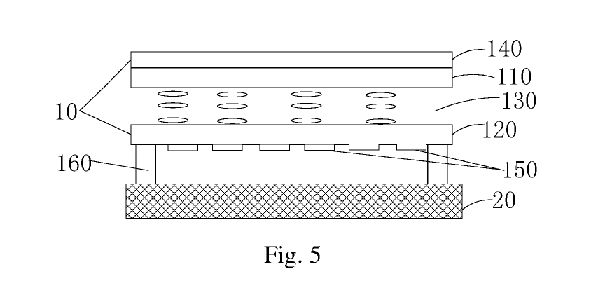

As shown in FIG. 5, which shows the 3D display device, the grating structure 20 is formed as an OLED display screen and arranged at a rear side of the display panel 10. The OLED display screen includes a plurality of light-emitting units arranged parallel to each other. The light-emitting units may form the transparent portions of the grating structure in the case of emitting light, and form the nontransparent portions of the grating structure in the case of not emitting light. The OLED display screen is of a structure with a common OLED display panel known in the art, and thus will not be particularly defined herein.

In the above-mentioned 3D display device, the grating structure 20 is arranged in back of the display panel, and the OLED display screen functions as a backlight unit of the display panel 10. Through the light emitted by the plurality of light-emitting units spaced apart from each other, the left and right eyes may view different views, which may then be combined in the user's brain to form a 3D image.

In the above 3D display device, as shown in FIG. 5, the display panel 10 includes a color filter substrate 110, an array substrate 120, a liquid crystal layer 130 arranged between the color filter substrate 110 and the array substrate 120, a first polarizer 140 arranged above the color filter substrate 110, and a second polarizer arranged below the array substrate 120. In a possible embodiment of the present disclosure, the array substrate 120 may be formed as a cover plate for packaging the grating structure 20 (i.e., the OLED display screen). The second polarizer arranged on the array substrate 120 may include a plurality of metal wire-grid polarizers 150 for replacing a conventional polarizer. Due to the resistance to high temperature of the metal wire-grid polarizers 150, the array substrate 120 may be packaged with the OLED display screen through a sealant 160 after the array substrate 120 is manufactured, so as to form the 3D display device.

FIG. 5 merely shows an embodiment of the 3D display device including the above-mentioned controlling apparatus. It should be appreciated that, the 3D display device may be of one of other various structures, which will not be particularly defined herein.

According to the method and apparatus for controlling the 3D display device, and the 3D display device in the embodiments of the present disclosure, within the display period for one frame, in the case of switching from the first time period into the second time period, each of the left eye and the right eye of the user may view the view at different effects. As compared with the related art, it is able for each of the left eye and the right eye to acquire more image information, thereby to improve the PPI while achieving the 3D display effect.

The above are merely the optional embodiments of the present disclosure. Obviously, a person skilled in the art may make further modifications and improvements without departing from the spirit of the present disclosure, and these modifications and improvements shall also fall within the scope of the present disclosure.

1. A method for controlling a three-dimensional (3D) display device, the 3D display device comprising a display panel for displaying a two-dimensional (2D) image and a grating structure cooperating with the display panel to provide a 3D display effect, the method comprising:
within a first time period for outputting one frame, applying a first control signal, to enable a left eye of a user to view a first view on the display panel at a first effect through the grating structure, and enable a right eye of the user to view a second view on the display panel at the first effect through the grating structure; and
within a second time period for outputting the one frame, applying a second control signal, to enable the left eye of the user to view the first view on the display panel at a second effect through the grating structure, and enable the right eye of the user to view the second view on the display panel at the second effect through the grating structure.

2. The method according to claim 1, wherein
the applied first control signal comprises a first signal applied to the display panel and a second signal applied to the grating structure; and
the applied second control signal comprises a third signal different from the first signal and applied to the display panel, and a fourth signal identical to the second signal and applied to the grating structure.

3. The method according to claim 1, wherein
applying the first control signal to enable the left eye of the user to view the first view on the display panel at the first effect through the grating structure and enable the right eye of the user to view the second view on the display panel at the first effect through the grating structure comprises:
enabling a first group of gratings of the grating structure, which are spaced apart from each other, to be transparent portions, enabling a second group of gratings each arranged between the adjacent gratings in the first group to be nontransparent portions, enabling a plurality of first pixel units arranged on the display panel and spaced apart from each other to display the first view at the first effect, and enabling a plurality of second pixel units each arranged between the adjacent first pixel units on the display panel to display the second view at the first effect; and
applying a second output signal to enable the left eye of the user to view the first view on the display panel at the second effect through the grating structure and enable the right eye of the user to view the second view on the display panel at the second effect through the grating structure comprises:
enabling the first group of gratings spaced apart from each other to be transparent portions, enabling the second group of gratings spaced apart from each other to be nontransparent portions, enabling the first pixel units to display the first view at the second effect, and enabling the second pixel units to display the second view at the second effect.

4. The method according to claim 1, wherein
the applied first control signal comprises a first signal applied to the display panel and a second signal applied to the grating structure;
the applied second control signal comprises a third signal different from the first signal and applied to the display panel, and a fourth signal different from the second signal and applied to the grating structure; and
transparent portions of the grating structure are located at different positions in accordance with the second signal and the fourth signal.

5. The method according to claim 1, wherein
applying the first control signal to enable the left eye of the user to view the first view on the display panel at the first effect through the grating structure and enable the right eye of the user to view the second view on the display panel at the first effect through the grating structure comprises:
enabling a first group of gratings of the grating structure, which are spaced apart from each other, to be transparent portions, enabling a second group of gratings each arranged between the adjacent gratings in the first group to be nontransparent portions, enabling a plurality of first pixel units arranged on the display panel and spaced apart from each other to display the first view at the first effect, and enabling a plurality of second pixel units each arranged between the adjacent first pixel units on the display panel to display the second view at the first effect; and
applying the second control signal to enable the left eye of the user to view the first view on the display panel at the second effect through the grating structure and enable the right eye of the user to view the second view on the display panel at the second effect through the grating structure comprises:
enabling the second group of gratings of the grating structure to be transparent portions, enabling the first group of gratings to be nontransparent portions, enabling the plurality of second pixel units spaced apart from each other on the display panel to display the first view at the second effect, and enabling the plurality of first pixel units spaced apart from each other on the display panel to display the second view at the second effect.

6. The method according to claim 1, wherein
within the first time period for outputting the one frame, the first control signal is applied, to enable the left eye of the user to view on the display panel the first view outputted by a plurality of first pixel units spaced apart from each other through the grating structure, to enable the left eye of the user to view the first view at the first effect; and enable the right eye of the user to view on the display panel the second view outputted by a plurality of second pixel units spaced apart from each other through the grating structure, to enable the right eye of the user to view the second view at the first effect, and
within the second time period for outputting the one frame, the second control signal is applied, to enable the left eye of the user to view on the display panel the first view outputted by the plurality of second pixel units through the grating structure, to enable the left eye of the user to view the first view at the second effect; and enable the right eye of the user to view on the display panel the second view outputted by the plurality of first pixel units through the grating structure, to enable the right eye of the user to view the second view at the second effect.

7. The method according to claim 1, wherein the first time period and the second time period form a display period for one frame.

8. The method according to claim 1, wherein
the first effect is different from the second effect;
the first effect is used to represent positions of pixel units on the display panel corresponding to the first view and the second view within the first time period, brightness values of at least parts of the pixel units on the display panel within the first time period, and/or contrast values of at least parts of the pixel units on the display panel within the first time; and
the second effect is used to represent positions of pixel units on the display panel corresponding to the first view and the second view within the second time period, brightness values of at least parts of the pixel units on the display panel within the second time period, and/or contrast values of at least parts of the pixel units on the display panel within the second time period.

9. An apparatus for controlling a three-dimensional (3D) display device, the 3D display device comprising a display panel for displaying a two-dimensional (2D) image and a grating structure cooperating with the display panel to provide a 3D display effect, the apparatus comprising:
a first controller configured to, within a first time period for outputting one frame, apply a first control signal to enable a left eye of a user to view a first view on the display panel at a first effect through the grating structure, and enable a right eye of the user to view a second view on the display panel at the first effect through the grating structure; and
a second controller configured to, within a second time period for outputting one frame, apply a second control signal to enable the left eye of the user to view the first view on the display panel at a second effect through the grating structure, and enable the right eye of the user to view the second view on the display panel at the second effect through the grating structure.

10. The apparatus according to claim 9, wherein
the first control signal applied by the first controller comprises a first signal applied to the display panel and a second signal applied to the grating structure; and
the second control signal applied by the second controller comprises a third signal different from the first signal and applied to the display panel, and a fourth signal identical to the second signal and applied to the grating structure.

11. The apparatus according to claim 9, wherein
the first control signal applied by the first controller comprises a first signal applied to the display panel and a second signal applied to the grating structure; and
the second control signal applied by the second controller comprises a third signal different from the first signal and applied to the display panel, and a fourth signal different from the second signal and applied to the grating structure.

12. The apparatus according to claim 9, wherein
the first effect is different from the second effect;
the first effect is used to represent positions of pixel units on the display panel corresponding to the first view and the second view within the first time period, brightness values of at least parts of the pixel units on the display panel within the first time period, and/or contrast values of at least parts of the pixel units on the display panel within the first time; and
the second effect is used to represent positions of pixel units on the display panel corresponding to the first view and the second view within the second time period, brightness values of at least parts of the pixel units on the display panel within the second time period, and/or contrast values of at least parts of the pixel units on the display panel within the second time period.

13. A three-dimensional (3D) display device, comprising the apparatus according to claim 9, the display panel for displaying the 2D image, and the grating structure cooperating with the display panel to provide the 3D display effect.

14. The 3D display device according to claim 13, wherein
the grating structure is formed as an organic light-emitting diode (OLED) display screen and arranged at a rear side of the display panel;
the OLED display screen comprises a plurality of light-emitting units arranged parallel to each other; and
each light-emitting unit forms the transparent portion of the grating structure in the case that the light emitting unit emits light, and forms the nontransparent portion of the grating structure in the case that the light emitting unit does not emit light.

15. The 3D display device according to claim 13, wherein
the first control signal applied by the first controller comprises a first signal applied to the display panel and a second signal applied to the grating structure; and
the second control signal applied by the second controller comprises a third signal different from the first signal and applied to the display panel, and a fourth signal identical to the second signal and applied to the grating structure.

16. The 3D display device according to claim 13, wherein
the first control signal applied by the first controller comprises a first signal applied to the display panel and a second signal applied to the grating structure; and
the second control signal applied by the second controller comprises a third signal different from the first signal and applied to the display panel, and a fourth signal different from the second signal and applied to the grating structure.

17. The 3D display device according to claim 13, wherein
the first effect is different from the second effect;
the first effect is used to represent positions of pixel units on the display panel corresponding to the first view and the second view within the first time period, brightness values of at least parts of the pixel units on the display panel within the first time period, and/or contrast values of at least parts of the pixel units on the display panel within the first time; and
the second effect is used to represent positions of pixel units on the display panel corresponding to the first view and the second view within the second time period, brightness values of at least parts of the pixel units on the display panel within the second time period, and/or contrast values of at least parts of the pixel units on the display panel within the second time period.

18. The 3D display device according to claim 15, wherein
the grating structure is formed as an OLED display screen and arranged at a rear side of the display panel;
the OLED display screen comprises a plurality of light-emitting units arranged parallel to each other; and
each light-emitting unit forms the transparent portion of the grating structure in the case that the light emitting unit emits light, and forms the nontransparent portion of the grating structure in the case that the light emitting unit does not emit light.

19. The 3D display device according to claim 16, wherein
the grating structure is formed as an OLED display screen and arranged at a rear side of the display panel;
the OLED display screen comprises a plurality of light-emitting units arranged parallel to each other; and
each light-emitting unit forms the transparent portion of the grating structure in the case that the light emitting unit emits light, and forms the nontransparent portion of the grating structure in the case that the light emitting unit does not emit light.

20. The 3D display device according to claim 17, wherein
the grating structure is formed as an OLED display screen and arranged at a rear side of the display panel;
the OLED display screen comprises a plurality of light-emitting units arranged parallel to each other; and
each light-emitting unit forms the transparent portion of the grating structure in the case that the light emitting unit emits light, and forms the nontransparent portion of the grating structure in the case that the light emitting unit does not emit light.
